(19) United States
(12) Patent Application Publication
(10) Pub. No.: US 2015/0225569 A1
(43) Pub. Date: Aug. 13, 2015

(54) METHOD FOR PRODUCING HOLLOW PARTICLES, HOLLOW PARTICLES, ANTIREFLECTION COATING, AND OPTICAL ELEMENT

(71) Applicant: CANON KABUSHIKI KAISHA, Tokyo (JP)

(72) Inventors: Yu Kameno, Yokohama-shi (JP); Masanobu Ogane, Yokohama-shi (JP); Kikuo Okuyama, Higashi-Hiroshima-shi (JP)

(21) Appl. No.: 14/415,576

(22) PCT Filed: Jul. 12, 2013
(86) PCT No.: PCT/JP2013/004312

§ 371 Date: Jan. 16, 2015

(30) Foreign Application Priority Data
Jul. 20, 2012 (JP) 2012-161544

(51) Int. Cl. C09D 5/00

(52) U.S. Cl. CPC C09D 5/006; C08K 7/24

(57) ABSTRACT

A hollow particle and a method for producing hollow particles are provided. The shell of the particle(s) is a continuous layer containing magnesium fluoride and thus is strong.

A hollow particle has a continuous shell containing magnesium fluoride and an at least partially removed hollow core. A method for producing hollow particles includes forming core-shell particles having a core particle and a continuous shell containing magnesium fluoride and removing at least a portion of the core particle from the core-shell particles to produce a hollow core. The core-shell particles can be formed by adding an aqueous solution of a magnesium salt and an aqueous solution containing fluoride ions to an aqueous dispersion containing the core particles at a temperature of 10 degrees Celsius to 30 degrees Celsius, both inclusive, and then heating the combined liquid at a temperature of 50 degrees Celsius to 80 degrees Celsius, both inclusive.

### TECHNICAL FIELD

The present invention relates to a method for producing hollow particles, hollow particle, an antireflection coating made using the hollow particles, and an optical element having the antireflection coating.

### BACKGROUND ART

Antireflection coatings reduce the reflection of light occurring at the light-emitting and light-receiving surfaces of optical elements and ensure the desired optical characteristics of the devices, and such coatings are formed as a monolayer optical film having a certain refractive index and a thickness of several tens to several hundreds of nanometers or as a stack of two or more of such films having different refractive indices. Examples of methods used to produce antireflection coatings include vacuum film formation techniques such as vapor deposition or sputtering as well as wet film formation techniques such as dip coating or spin coating.

The uppermost layer of an antireflection coating is made of a transparent and low-refractive-index material. Examples of such materials include inorganic ones such as silica, magnesium fluoride, and calcium fluoride as well as organic ones such as silicones and amorphous fluoropolymers.

Some more recent antireflection coatings use the refractive index of air, 1.0, to be more effective in reducing the reflectance of optical elements than older ones. Pores in a layer of silica or magnesium fluoride reduce the refractive index of the layer. For example, a 30% (volume) space in a magnesium fluoride thin film having a refractive index of 1.38 reduces the refractive index of the film to 1.27.

An example of a method used to form such pores is to prepare silica or magnesium fluoride fine particles and process these particles into a film with a binder. The pores are formed between the fine particles, giving a low refractive index to the resulting film (refer to PTL 1 and PTL 2).

Another example used to form such pores is to use hollow silica particles, i.e., particles containing a void. Hollow particles of magnesium fluoride, a material having a lower refractive index than silica, can also be used to make antireflection coatings. Because of the low refractive index, magnesium fluoride allows the resulting antireflection coatings to have a lower refractive index than ones made using hollow silica particles. Furthermore, hollow particles of magnesium fluoride contain a smaller void than hollow silica particles if the refractive indices are equal; hollow magnesium fluoride particles can have a thicker wall (shell) and thus can be stronger than silica-based ones (refer to PTL 3 and PTL 4).

### CITATION LIST

### Patent Literature

### PTL 1: Japanese Patent Laid-Open No. 2006-151800

### PTL 2: International Publication No. 02/018982

### PTL 3: Japanese Patent Laid-Open No. 2001-233611

### PTL 4: International Publication No. 2007/148938 A1

### SUMMARY OF INVENTION

### Technical Problem

The hollow magnesium fluoride particles described in PTL 4 are produced by a method including preparing magnesium fluoride nanoparticles and then attaching the nanoparticles to core particles to form a layer of magnesium fluoride. The use of this magnesium fluoride layer, which is an assembly of particles, leads to the shell lacking sufficient strength, thereby causing the particles to be destroyed during subsequent operations such as hollowing out the particles or dispersing the particles in a medium to produce paint.

The present invention, made under these circumstances, provides a hollow particle and a method for producing hollow particles. The shell of the particle(s) is a continuous layer containing magnesium fluoride and thus is strong.

The present invention also provides an antireflection coating and an optical element having an antireflection coating. The antireflection coating is made using hollow particles having a strong shell containing magnesium fluoride and thus combines excellent strength and a low refractive index.

### Solution to Problem

A method for producing hollow particles that solves the above problem includes obtaining core-shell particles having a core particle and a shell containing magnesium fluoride and removing at least a portion of the core particle from the core-shell particles. The core-shell particles can be obtained by mixing an aqueous dispersion containing the core particles, an aqueous solution containing magnesium, and an aqueous solution containing fluorine at a temperature of 10 degrees Celsius to 30 degrees Celsius, both inclusive, to form a mixture and then heating the mixture at a temperature of 50 degrees Celsius to 80 degrees Celsius, both inclusive.

A hollow particle that solves the above problem has a continuous shell containing magnesium fluoride.

Another aspect of the invention is an antireflection coating made using the aforementioned hollow particles.

Yet another aspect of the invention is an optical element having the aforementioned antireflection coating.

Further features of the present invention will become apparent from the following description of exemplary embodiments with reference to the attached drawings.

### BRIEF DESCRIPTION OF DRAWINGS

FIG. 1 is a schematic diagram illustrating an embodiment of the invention.

FIG. 2 is a schematic diagram illustrating a method for producing hollow particles according to an embodiment of the invention.

FIG. 3 is a transmission electron microscopic (TEM) image of the core-shell particles produced in Example 1.

FIG. 4 is a TEM image of the hollow particles produced in Example 6.

FIG. 5 is a TEM image of the core-shell particles produced in Comparative Example 1.

FIG. 6 is a TEM image taken in Comparative Example 1 after the particles were hollowed out.

### DESCRIPTION OF EMBODIMENTS

The following describes some preferred embodiments of the present invention in detail with reference to the drawings.

A hollow particle according to an aspect of the invention has a continuous shell containing magnesium fluoride and an at least partially removed hollow core.

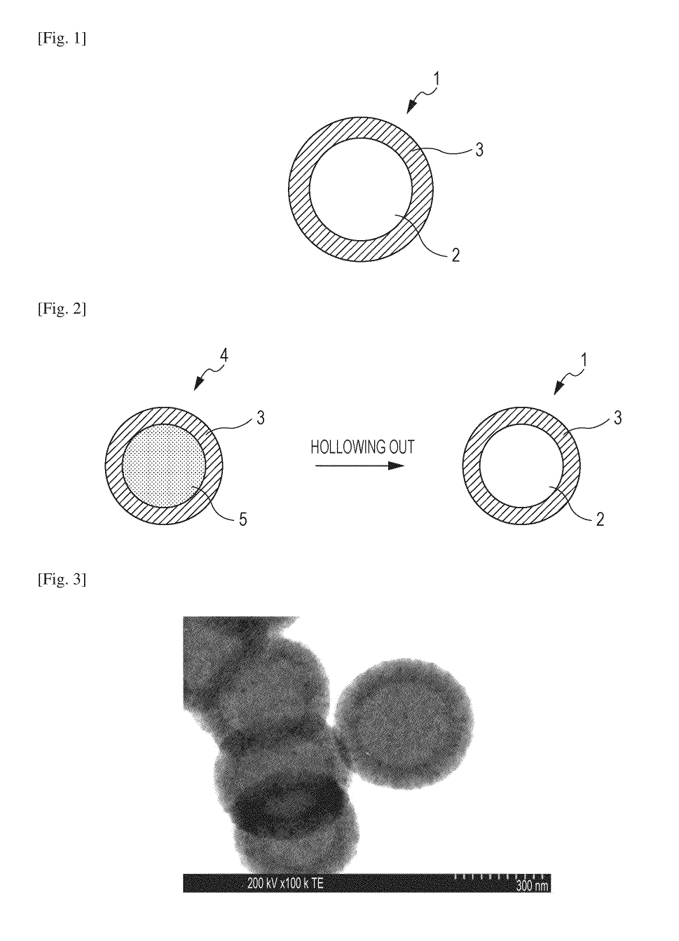

FIG. 1 is a schematic diagram illustrating an embodiment of a hollow particle according to this aspect of the invention. A hollow particle 1 according to this embodiment has a hollow core 2 and a shell 3. The hollow core 2 has been removed at least in part, and the shell 3 is a continuous layer containing magnesium fluoride.

Hollow particles according to this embodiment of the invention, which have a continuous shell containing magnesium fluoride, can be produced without damage despite treatment for hollowing out the core and are strong enough to be dispersed in a medium without being broken.

The shell provided in this embodiment of the invention contains fluorine, leading to a low refractive index of the particle. Magnesium, coexisting with fluorine in the shell, stabilizes the particle with excellent resistance to environmental factors without affecting the low refractive index. The refractive index of the particle is as low as 1.2 to 1.3 because of the void existing in the particle. Thus, hollow particles according to this embodiment of the invention can be used in low-refractive-index layers for antireflection coatings to ensure low reflectance of the coatings.

The shell of a hollow particle according to this embodiment of the invention is a continuous layer containing magnesium fluoride. The term continuous layer, as used herein, refers to a layer formed by crystal nuclei undergoing the aggregation and growth process and solid-state relaxation on the surface of a core particle. The continuous nature of the layer ensured by solid-state relaxation makes the layer a shell stronger than ones produced by attaching particles that have completed solid-state relaxation.

The average particle diameter of hollow particles according to this embodiment of the invention can be in the range of 30 nm to 200 nm, both inclusive. It is difficult to produce core particles for hollow particles having an average particle diameter smaller than 30 nm in a consistent manner. An average particle diameter exceeding 200 nm causes the hollow particles to scatter light in antireflection coatings because of their large size.

The thickness of the shell of hollow particles according to this embodiment of the invention can be in the range of 10% to 35%, both inclusive, of the average particle diameter of the hollow particles. A thickness of the shell smaller than 10% of the average particle diameter of the hollow particles renders the particles lacking sufficient strength. When the thickness of the shell exceeds 35% of the average particle diameter of the hollow particles, the void is too small to have significant effects on the refractive index.

A method for producing hollow particles according to another embodiment of the invention includes obtaining core-shell particles having a core particle and a continuous shell containing magnesium fluoride and removing at least a portion of the core particle from the core-shell particles to form the hollow particles. The core-shell particles can be obtained by adding an aqueous solution containing magnesium and an aqueous solution containing fluorine to an aqueous dispersion containing the core particles at a temperature of 10 degrees Celsius to 30 degrees Celsius, both inclusive, and then heating the combined liquid at a temperature of 50 degrees Celsius to 80 degrees Celsius, both inclusive.

FIG. 2 is a schematic diagram illustrating a method for producing hollow particles according to this embodiment of the invention. Core-shell particles 4 having a core particle 5 and a continuous shell 3 containing magnesium fluoride are first obtained. At least a portion of the core particle 5 of the core-shell particles 4 is then removed to form a hollow core 2 (hollowing out). As a result, hollow particles 1 are obtained.

The production of continuous-shell hollow particles according to this embodiment of the invention begins with the formation of crystal nuclei containing at least fluorine and magnesium. The crystal nuclei adhere to core particles and cover them, and then magnesium and fluorine react with each other at the crystal nuclei to form a continuous layer around the core particles.

The core particles may be made of any organic or inorganic material that allows at least a portion of the core particles to be removed later. Examples of inorganic materials that can be used include SiO₂, which is soluble in alkalis, and calcium carbonate, which is soluble in acids.

Examples of organic materials that can be used include vinyl polymers that are small in size and have a relatively narrow size distribution, such as polymers of styrene, acrylic esters, or vinyl esters. Polystyrene can make the resulting particles small and highly uniform in particle diameter.

The average particle diameter of the core particles can be in the range of 10 nm to 500 nm, both inclusive, preferably 10 nm to 160 nm, both inclusive.

The core particles used in this embodiment of the invention, which are fine particles, are required to have a negative zeta potential. Crystal nuclei containing fluorine and magnesium have a positive zeta potential, with which the crystal nuclei can adhere to the core fine particles and cover them.

The potential of fine particles depends on the material of the particles. However, it is possible to change the potential of the fine particles by modifying the surface of the particles with a functional group. Polymer particles can be surface-modified with a functional group by preparing them using agents appropriate for the intended zeta potential, e.g., an appropriate polymerization initiator. The zeta potential of inorganic particles can also be controlled; this is achieved by introducing a functional group to the surface of the particles through chemical reaction. Examples of functional groups having a negative zeta potential include a sulfonate ion, a carboxylate ion, and a peroxodisulfate ion.

The aqueous solution containing magnesium can be an aqueous solution of a magnesium salt. Examples of solutes for this aqueous solution include magnesium nitrate, magnesium chloride, magnesium sulfate, magnesium carbonate, magnesium phosphate, and hydrates of these salts.

The aqueous solution containing fluorine can be an aqueous solution containing fluoride ions. Examples of solutes for this aqueous solution include sodium fluoride, potassium fluoride, hydrofluoric acid, and ammonium fluoride.

The aqueous dispersion containing the core particles, the aqueous solution containing magnesium, and the aqueous solution containing fluorine are combined. For example, the aqueous solution containing magnesium is added to the aqueous dispersion containing the core particles, and the aqueous solution containing fluorine is added to the resulting mixture. The three liquids can be combined in any order; it is possible to add the aqueous dispersion containing the core particles to the aqueous solution containing magnesium and then add the aqueous solution containing fluorine to the resulting mixture. It is also possible to combine the three liquids at once and then mix. The liquids can be at a temperature of 10 degrees Celsius to 30 degrees Celsius at the time when they are combined. Crystal nuclei can form only when the reaction between magnesium and fluorine is sufficiently slow. The crystal nuclei start to form as soon as the aqueous solution containing magnesium fluoride and the aqueous solution containing fluorine come into contact. Thus, a typical scheme is to adjust the temperature of an aqueous solution of a magnesium salt and an aqueous solution containing fluoride ions within the range of 10 degrees Celsius to 30 degrees Celsius, both inclusive, and then add one solution to the other and allow the solutions to react with each other. A reaction temperature lower than 10 degrees Celsius causes the reaction and, therefore, the formation of the crystal nuclei to be too slow for practical production. Reaction at a temperature exceeding 30 degrees Celsius causes the crystal nuclei to grow into colloidal particles of magnesium fluoride before adhering to the core particles and covering them. These colloidal particles adhere to the core particles and cover them, and the shell will be insufficiently strong. The duration of the reaction can be in the range of 1 minute to 30 minutes, both inclusive.

The reaction temperature after the three liquids are combined can be in the range of 50 degrees Celsius to 80 degrees Celsius, both inclusive, preferably 60 degrees Celsius to 75 degrees Celsius, both inclusive. The crystal nuclei covering the core particles can grow only when the reaction proceeds sufficiently fast. A reaction temperature lower than 50 degrees Celsius at this stage causes the crystal nuclei to tend to increase in number rather than growing in size. In this case there will be many crystal nuclei not adhering to the surface of the core particles, and these free crystal nuclei will form a large amount of magnesium fluoride colloid. A reaction temperature exceeding 80 degrees Celsius at this stage also causes the crystal nuclei to form too fast and a large amount of magnesium fluoride colloid to be formed. The duration of the reaction at this stage can be in the range of 1 minute to 2 hours, both inclusive.

The concentration of the aqueous solution containing magnesium can be in the range of 0.05 mol/L to 0.2 mol/L, both inclusive. The concentration of the aqueous solution containing fluoride can be in the range of 0.1 mol/L to 0.4 mol/L, both inclusive. Too low a concentration of the magnesium source or the fluorine source causes the crystal nuclei to form and adhere to the surface of the core particles too slowly. Too high a concentration of the magnesium source or the fluorine source causes too many crystal nuclei to form. In this case there will be many crystal nuclei not adhering to the surface of the core particles, and these free crystal nuclei will form a large amount of magnesium fluoride colloid.

At least a portion of the core particle is removed from the core-shell particles to form a hollow core. It is also possible to remove the entire core particle. The core particle of the core-shell fine particles can be removed by several ways. If the core particle is made of an inorganic material, the core particle can be removed by using an agent that dissolves the material such as an appropriate acid or alkali. If the core particle is made of an organic material, the core particle can be removed by dissolution in a solvent or firing to turn the core particle into a gas, for example. When the core is made of an organic material and removed by firing the core-shell particles to turn the core into a gas, the heating temperature can be in the range of 200 degrees Celsius to 350 degrees Celsius, both inclusive. Heating at a temperature lower than 200 degrees Celsius is insufficient to remove the core particle because the carbon-carbon bonds in the organic material cannot be broken at such a low temperature. Heating at a temperature of 350 degrees Celsius or less allows the organic material forming the core particle to stay between the fine particles of magnesium fluoride and reinforce the shell.

The core does not always contain only one void; for example, it is also possible that two or more particles collectively form the core.

Another embodiment of the invention is an antireflection coating made using the aforementioned hollow particles.

Dispersions of hollow particles or core-shell particles obtained in accordance with the aforementioned production method can be used to prepare coating liquids for antireflection coatings. If hollow particles are used, slurry obtained by dispersing the hollow particles in a medium can be used as a coating liquid or as a raw material for coating liquids.

If core-shell particles are used, the aqueous dispersion of the core-shell particles can be directly used as a coating liquid. It is also possible to isolate the core-shell particles by processes such as solvent displacement, centrifugation, or filtration, disperse the isolated particles in an organic solvent, and use the resulting dispersion as a coating liquid or as a raw material for coating liquids. The use of a coating liquid containing the core-shell particles allows a coating of hollow particles to be formed directly on a substrate. This is achieved by applying the coating liquid containing the core-shell particles to the substrate and then firing the applied liquid to hollow out the core-shell particles by removing the core particle. In this way, an antireflection coating formed using hollow particles obtained by the aforementioned method is produced.

The coating liquid may contain a composition that serves as a binder for fixing the hollow particles to the substrate. This binder composition can be a material having a low refractive index and sufficiently high scratch resistance such as pencil hardness when hardened, and examples include sol-gel compositions of silica, crosslinking acrylic resins, and fluorinated acrylic resins. It is also possible to first apply a dispersion of the hollow particles to the substrate and then apply such a binder composition while allowing the binder composition to penetrate between the hollow particles to fix them to the substrate.

If core-shell particles are used, the antireflection coating can also be obtained by first forming a layer of the core-shell particles, then forming a layer of the binder, and finally hardening the layers by firing or other processes so that the removal of the core particle also occurs.

The dispersion of hollow particles or core-shell particles may further contain solid particles.

The substrate to which the coating liquid is applied can be made of glass, a resin, or any other suitable material. The substrate can be in any shape; for example, flat, curved, concave, convex, and film-like substrates can be used.

The coating liquid can be applied to the substrate by any suitable method. All methods commonly used with liquid coating agents can be used, including dip coating, spin coating, spray coating, and roll coating.

The applied coating liquid is then fire-dried, using an oven, a hot plate, an electric furnace, or the like. The temperature and duration of fire-drying are so adjusted that the organic solvent contained in the hollow particles is evaporated without damage to the substrate. Usually, the fire-drying temperature can be 350 degrees Celsius or less.

Usually, the coating liquid can be applied once. It is also possible to repeat several cycles of application and drying.

There may be one or more additional layers, e.g., layers having a high or intermediate refractive index, between the substrate and the layer of the coating liquid. Examples of materials for such high- or intermediate-refractive-index layers include zirconium oxide, titanium oxide, tantalum oxide, niobium oxide, hafnium oxide, alumina, silica, and magnesium fluoride.

The layer of the coating liquid may be further coated with a functional layer for purposes such as repelling water and oil. Such a functional layer can be formed using a paint containing fluorine or a silicone paint, for example.

Such layers having a selected refractive index or functionality can be formed by processes such as vacuum deposition, sputtering, CVD, dip coating, spin coating, or spray coating.

Forming such an antireflection coating on a transparent material such as a plastic or glass material significantly reduces the reflectance of the surface of the material.

Another embodiment of the invention is an optical element having the aforementioned antireflection coating. Optical elements according to this embodiment of the invention, offering reduced reflection of light at the light-emitting and light-receiving surfaces thereof, can be used in imaging devices such as still and video cameras as well as in projectors such as liquid-crystal projectors and optical scanners for electrophotographic equipment.

### EXAMPLES

The following illustrates some examples of the present invention to describe some embodiments of the invention in more detail. The present invention is not limited to these examples within the scope thereof.

### Example 1

### Production of Core Particles

In a nitrogen atmosphere 240 mL of water was heated at 80 degrees Celsius, 10 g of styrene was added thereto, and the mixture was stirred. After 1 mL of 0.1 g/mL aqueous solution of potassium persulfate was added, the solution was heated at 80 degrees Celsius for 4 hours. In this way, an aqueous dispersion of core particles having an average particle diameter of 300 nm (a polystyrene particle aqueous dispersion) was obtained.

### Production of Core-Shell Particles

One (1) milliliter of the polystyrene particle aqueous solution was added to 80 mL of 0.05 mol/L aqueous solution of Mg(NO₃)₂.6H₂O, and the mixture was cooled to 30 degrees Celsius and stirred. To the stirred solution 40 mL of 0.1 mol/L aqueous solution of ammonium fluoride was added. The resulting mixture was heated at 80 degrees Celsius for 1 hour.

A dried film of the obtained solution was observed under a transmission electron microscope (TEM) and characterized for elemental composition using an energy-dispersive X-ray spectroscopy system (EDS), confirming that core-shell particles had been formed and the shell contained fluorine and magnesium. FIG. 3 is a TEM image. The resulting particles had a continuous shell as a result of solid-state relaxation, and the shell had grown outwards from the core like an array of pillars.

### Production of Hollow Particles

The obtained core-shell particles were fired at 350 degrees Celsius for 1 hour. The fired particles were observed under a TEM and characterized for elemental composition using an EDS in the same way as the unfired core-shell particles, confirming that hollow particles had been formed. The hollow particles had an average particle diameter of 450 nm and a shell thickness of 75 nm. The shell contained fluorine, magnesium, and carbon.

### Example 2

### Production of Core Particles

A polystyrene particle aqueous dispersion was obtained as in Example 1 except that the amount of styrene was 5 g. The average particle diameter of core particles in this example was 150 nm.

### Production of Core-Shell Particles

Three (3) milliliters of the polystyrene particle aqueous dispersion was added to 80 mL of 0.1 mol/L aqueous solution of Mg(NO₃)₂.6H₂O, and the mixture was cooled to 10 degrees Celsius and stirred. To the stirred solution 40 mL of 0.2 mol/L aqueous solution of ammonium fluoride was added. The resulting mixture was heated at 50 degrees Celsius for 1 hour.

A dried film of the obtained solution was observed under a TEM and characterized for elemental composition using an EDS, confirming that core-shell particles had been formed and the shell contained fluorine and magnesium. The average particle diameter of the core-shell particles was 210 nm, and the shell was a continuous layer as in Example 1. The shell was also analyzed for elemental composition in the same way as the core-shell particles and found to contain fluorine and magnesium.

Production of Hollow Particles

The obtained core-shell particles were fired at 300 degrees Celsius for 1 hour. The fired particles were observed under a TEM in the same way as the unfired core-shell particles, confirming that hollow particles had been formed. The hollow particles had an average particle diameter of 210 nm and a shell thickness of 30 nm. The shell was characterized for elemental composition in the same way as the core-shell particles and found to contain fluorine, magnesium, and carbon.

### Example 3

### Production of Hollow Particles

Eighty (80) milliliters of 0.1 mol/L aqueous solution of Mg(NO₃)₂.6H₂O was cooled to 20 degrees Celsius and stirred, and 8 mL of an aqueous dispersion containing SO₃-modified polystyrene latex particles (micromod micromer particles with an average particle diameter of 15 nm) as core particles was added. To the cooled and stirred solution 40 mL of 0.2 mol/L aqueous solution of ammonium fluoride was added. The resulting mixture was heated at 80 degrees Celsius for 1 hour.

A dried film of the obtained solution was observed under a TEM and characterized for elemental composition using an EDS, confirming that core-shell particles had been formed and the shell contained fluorine and magnesium. The average particle diameter of the core-shell particles was 30 nm. The shell of the obtained particles was a layer of heteroaggregated magnesium fluoride fine particles.

The obtained core-shell particles were fired at 350 degrees Celsius for 1 hour. The fired particles were observed under a TEM in the same way as the unfired core-shell particles, confirming that hollow particles had been formed. The hollow particles had an average particle diameter of 30 nm and a shell thickness of 7.5 nm. The shell was characterized for elemental composition in the same way as the core-shell particles and found to contain fluorine, magnesium, and carbon.

### Example 4

A polystyrene particle aqueous dispersion was obtained as in Example 1 except that the amount of styrene was 2 g. The average particle diameter of core particles in this example was 100 nm.

Sixty (60) milliliters of the polystyrene particle aqueous dispersion was added to 40 mL of 0.15 mol/L aqueous solution of Mg(NO₃)₂.6H₂O, and the mixture was cooled to 20 degrees Celsius and stirred. To the stirred solution 40 mL of 0.3 mol/L aqueous solution of ammonium fluoride was added. The resulting mixture was heated at 70 degrees Celsius for 1 hour.

A dried film of the obtained solution was observed under a TEM and characterized for elemental composition using an EDS, confirming that core-shell particles had been formed and the shell contained fluorine and magnesium. The average particle diameter of the core-shell particles was 330 nm, and the shell was a continuous layer formed as a result of solid-state relaxation.

The obtained core-shell particles were fired at 350 degrees Celsius for 1 hour. The fired particles were observed under a TEM in the same way as the unfired core-shell particles, confirming that hollow particles had been formed. The hollow particles had an average particle diameter of 330 nm and a shell thickness of 115 nm. The shell was characterized for elemental composition in the same way as the core-shell particles and found to contain fluorine, magnesium, and carbon.

### Comparative Example 1

### Production of Core-Shell Particles

Sixty (60) milliliters of the polystyrene particle aqueous dispersion prepared in Example 4 was added to 80 mL of 0.1 mol/L aqueous solution of Mg(NO₃)₂.6H₂O, and the mixture was heated to 80 degrees Celsius and stirred. To the stirred solution 40 mL of 0.2 mol/L aqueous solution of ammonium fluoride was added. The resulting mixture was heated at 80 degrees Celsius for 1 hour.

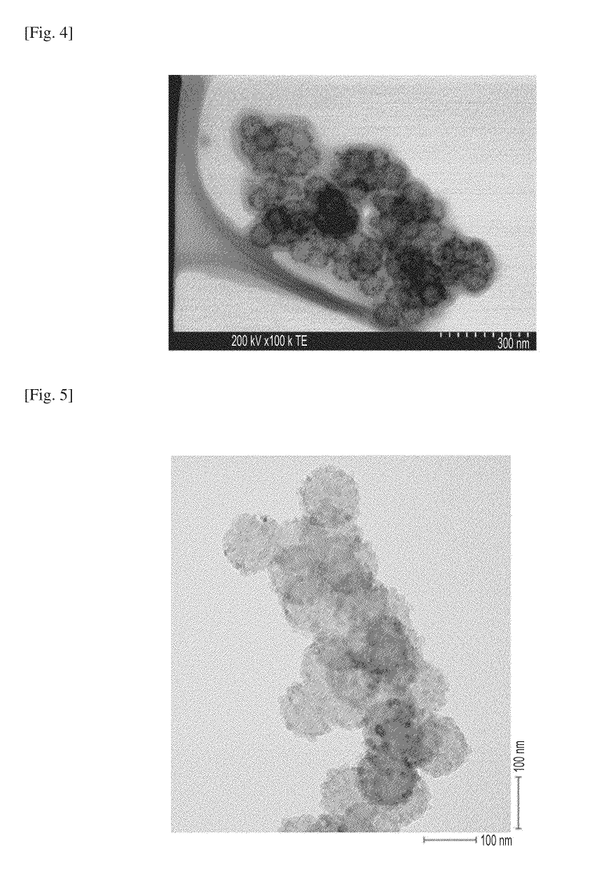

A dried film of the obtained solution was observed under a TEM and characterized for elemental composition using an EDS, confirming that core-shell particles had been formed and the shell contained fluorine and magnesium. The average particle diameter of the core-shell particles was 120 nm. FIG. 5 is a TEM image.

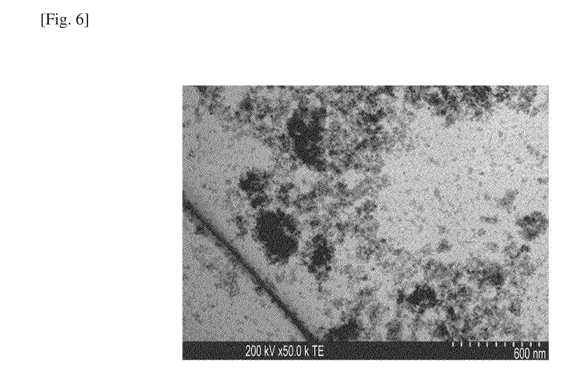

The shell of the obtained particles was a layer of magnesium fluoride fine particles adhering to the core particle. The obtained core-shell particles were fired at 350 degrees Celsius for 1 hour. The fired particles were observed under a TEM in the same way as the unfired core-shell particle; however, no hollow particles were observed, with there being only a magnesium fluoride fine powder. FIG. 6 is a TEM image.

### Example 5

A polystyrene particle aqueous dispersion was obtained as in Example 1 except that the amount of styrene was 1 g. The average particle diameter of core particles in this example was 50 nm.

Sixty (60) milliliters of the polystyrene particle aqueous dispersion was added to 40 mL of 0.1 mol/L aqueous solution of magnesium phosphate, and the mixture was cooled to 30 degrees Celsius and stirred. To the stirred solution 40 mL of 0.2 mol/L aqueous solution of ammonium fluoride was added. The resulting mixture was heated at 70 degrees Celsius for 1 hour.

The obtained core-shell particles were fired at 350 degrees Celsius for 1 hour. The fired particles were observed under a TEM, confirming that hollow particles had been formed. The hollow particles had an average particle diameter of 75 nm and a shell thickness of 12.5 nm. The shell was characterized for elemental composition and found to contain fluorine, magnesium, and carbon.

### Example 6

### Production of Core-Shell Particles

A polystyrene particle aqueous dispersion was obtained as in Example 1 except that the amount of styrene was 1 g. The average particle diameter of core particles in this example was 50 nm.

Sixty (60) milliliters of the polystyrene particle aqueous dispersion was added to 40 mL of 0.1 mol/L aqueous solution of Mg(NO₃)₂.6H₂O, and the mixture was cooled to 20 degrees Celsius and stirred. To the stirred solution 40 mL of 0.2 mol/L aqueous solution of ammonium fluoride was added. The resulting mixture was heated at 70 degrees Celsius for 1 hour.

A dried film of the obtained solution was observed under a TEM and characterized for elemental composition using an EDS, confirming that core-shell particles had been formed and the shell contained fluorine and magnesium. The average particle diameter of the core-shell particles was 75 nm. FIG. 4 is a TEM image. The shell of the obtained particles was a continuous layer formed as a result of solid-state relaxation with a thickness of 12.5 nm.

The obtained core-shell particles were fired at 350 degrees Celsius for 1 hour. The fired particles were observed under a TEM in the same way as the unfired core-shell particles, confirming that hollow particles had been formed. The hollow particles had an average particle diameter of 75 nm and a shell thickness of 12.5 nm. The shell was characterized for elemental composition in the same way as the core-shell particles and found to contain fluorine, magnesium, and carbon.

### Example 7

### Production of an Antireflection Coating

The core-shell particles prepared during the production of hollow particles in Example 6 were isolated by centrifugation. The isolated particles were washed by repeating the operations of adding water to the particles, stirring the resulting aqueous dispersion, and centrifuging the stirred dispersion. To the washed particles 1-methoxy-2-propanol was added, producing a coating dispersion containing the core-shell particles in 2 wt %. A drop of this coating liquid was formed into a film by spin coating on a BK7 flat substrate having a diameter of 39 mm.

This film was coated with a film formed by spin coating of a drop of another coating liquid, a liquid silica sol-gel (CN-1110 available from JGC Catalysts and Chemicals Ltd.) diluted to 1 wt % in 1-methoxy-2-propanol. The films were fired at 300 degrees Celsius for 3 hours, producing the antireflection coating of this example.

### Example 8

The substrate with an antireflection coating produced in Example 7 was analyzed for reflectance over the wavelength range of 400 nm to 700 nm using an Olympus reflectometer for lenses (USPM-RU). The refractive index determined from the reflectance at 550 nm was 1.26.

The substrate was then rubbed with a piece of lens-cleaning paper in 20 back and forth motions under a load of 300 g/cm², and the refractive index was measured in the way described above thereafter. The refractive index remained 1.26 and unchanged, with no flaws observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-161544, filed Jul. 20, 2012, which is hereby incorporated by reference herein in its entirety.

### INDUSTRIAL APPLICABILITY

Optical elements having an antireflection coating made using hollow particles according to an aspect of the invention, offering reduced reflection of light at the light-emitting and light-receiving surfaces thereof, can be used in imaging devices such as still and video cameras as well as in projectors such as liquid-crystal projectors and optical scanners for electrophotographic equipment.

The present invention provides a hollow particle and a method for producing hollow particles. The shell of the particle(s) is a continuous layer containing magnesium fluoride and thus is strong.

The present invention also provides an antireflection coating and an optical element having an antireflection coating. The antireflection coating is made using hollow particles having a strong shell containing magnesium fluoride and thus combines excellent strength and a low refractive index.

1. A method for producing hollow particles comprising:
forming core-shell particles having a core particle and a shell containing magnesium fluoride by combining an aqueous dispersion containing the core particles, an aqueous solution containing magnesium, and an aqueous solution containing fluorine to form a combined liquid and heating the combined liquid; and
removing at least a portion of the core particle from the core-shell particles.

2. The method for producing hollow particles according to claim 1, wherein the aqueous dispersion and the aqueous solutions are combined at a temperature of 10 degrees Celsius to 30 degrees Celsius, both inclusive.

3. The method for producing hollow particles according to claim 1, wherein the combined liquid is heated to a temperature of 50 degrees Celsius to 80 degrees Celsius, both inclusive.

4. The method for producing hollow particles according to claim 1, wherein the core particles are made of a vinyl polymer.

5. The method for producing hollow particles according to claim 1, wherein the at least a portion of the core particles is removed by heating the core-shell particles to a temperature of 200 degrees Celsius to 350 degrees Celsius, both inclusive.

6. A hollow particle comprising a continuous shell containing magnesium fluoride.

7. The hollow particle according to claim 6, wherein the shell contains carbon.

8. The hollow particles according to claim 6, wherein an average particle diameter of the hollow particles is in a range of 30 nm to 200 nm, both inclusive.

9. The hollow particles according to claim 6, wherein a thickness of the shell is in a range of 10% to 35%, both inclusive, of the average particle diameter of the hollow particles.

10. An antireflection coating comprising hollow particles produced by the method according to claim 1.

11. An optical element comprising the antireflection coating according to claim 10.
